(19) United States
(12) Patent Application Publication
(10) Pub. No.: US 2014/0089583 A1
(43) Pub. Date: Mar. 27, 2014

(54) LIBRARY APPARATUS, CONTROL METHOD OF THE SAME AND STORAGE MEDIUM STORING COMPUTER PROGRAM

(71) Applicant: NEC Corporation, Tokyo (JP)

(72) Inventors: YUUKI HAYAKAWA, Tokyo (JP); SHIGEYOSHI HASHI, Tokyo (JP); YOSHIYUKI ISHII, Tokyo (JP); WATARU NOGUCHI, Tokyo (JP); TAKAHIRO ICHIMURA, Tokyo (JP)

(73) Assignee: NEC Corporation, Tokyo (JP)

(21) Appl. No.: 14/037,558

(22) Filed: Sep. 26, 2013

(30) Foreign Application Priority Data
Sep. 26, 2012 (JP) 2012-212658

(51) Int. Cl. G06F 3/06

(52) U.S. Cl. CPC G06F 3/0686; G06F 3/0646; G06F 3/0608
USPC 711/115

(57) ABSTRACT

Disclosed is a library apparatus and the like capable of correlating a slot to be shared into which a recording medium has been thrown to an appropriate logical library easily.

In case that import processing to take the recording medium 5 into an external apparatus 7 is directed, a control unit 2 of a library apparatus 1 identifies, by referring to the logical library information 3, the logical library 6 connected to the external apparatus 7 which directed the import processing and correlates the slot 4 have been thrown the recording medium 5 to the identified logical library 6.

This application is based upon and claims the benefit of priority from Japanese Patent Application No. 2012-212658, filed on Sep. 26, 2012, the disclosure of which is incorporated herein in its entirety by reference.

### TECHNICAL FIELD

The present invention relates to a technical field for sharing a slot to be thrown in a recording medium or the like in a library apparatus or the like, for example, by a plurality of host devices.

### BACKGROUND ART

In recent years, an amount of information in information services necessary for execution of business in an enterprise and for living a social life is increasing, and thus a storage device storing such data appropriately in a server room, a data center or the like, for example, and which can be used timely is required.

For example, data which has been processed by a server such as an information processing device or the like, is saved in a storage device. On this occasion, an administrator in a data center and the like uses a library apparatus which records data in a magnetic recording tape medium housed in a carriageable cartridge, for example, for the purpose of such as backup and for long term storage of processed data.

Such library apparatus is shared as a storage device by a plurality of servers, for example. Therefore, because servers sharing a library apparatus communicate with each other by using a communication network which enables communication (hereinafter, it may be just called a “network”) in order to arbitrate competition caused when it is shared, increase of communications traffic, increase in a processing load in each server, and degradation of availability of a server which is made to wait by arbitration is caused.

Today, in a library apparatus which is shared by servers, there is used a technology in which, in order not to have to perform arbitration processing between the servers, the physical library apparatus is separated into a plurality of logical libraries in advance, each of the server is correlated to a separated logical library, and, from the server, it seems as if each of the server has an library apparatus that can be used independently.

Meanwhile, operations such as throwing a recording medium into the library apparatus for backup and long term storage and taking it out are often performed at a break of an operation, for example, and it is not so frequent operation. Therefore, because a frequency of taking in and out is not large, the number of physical throw-in slots provided in the library apparatus for taking a recording medium in and out is not large compared with the number of servers using the library apparatus (that is, the number of corresponding separated logical libraries).

Further, in a general library apparatus, when there is a single external apparatus, an operator throws a recording medium into a slot to be thrown in the recording medium (hereinafter, the slot may be called “throw-in slot”) provided in the library apparatus, and performs Import (hereinafter, referred to as “Import”) processing to register the thrown-in recording medium in the external apparatus.

However, when the library apparatus has a single (common use) throw-in slot and the throw-in slot is used by a plurality of servers, an operator cannot determine, only by an operation to just throw a recording medium into the throw-in slot, to which logical library in the library apparatus the thrown-in recording medium should be assigned.

Therefore, when throwing the recording medium into the throw-in slot in the library apparatus, it is needed for an operator operating the general library apparatus to designate the logical library to be assigned using an operation panel or the like installed around the throw-in slot, for example, in the library apparatus, and thus there is a problem that an operational procedure is complex.

In other words, such general library apparatus needs time consuming effort when work to correlate the thrown-in recording medium to the logical library is performed. Availability of the library apparatus declines by this.

Here, a technology described in patent document 1 (Japanese Patent Application Laid-Open No. 2005-122843) discloses a technique for performing data migration between systems connected to a library apparatus by separating the library apparatus into two logical libraries, and throwing a tape recording medium put out from one logical library into the other logical library automatically.

A technology disclosed in patent document 2 (Japanese Patent Application Laid-Open No. Hei 4 (1992)-0344920) discloses a technique which arbitrates, in access to an optical disc (recording medium) from a plurality of hosts, competition between the hosts by determining whether another hosts is using the recording medium or not by referring to a state management table that has registered an attribute for exclusively using an drive apparatus accessible to the recording medium.

The technology described in patent document 2 discloses a technique which reduces a processing time as a whole by omitting processing of removing a recording medium and of attaching a recording medium in a available manner using a command which inhibits another external apparatus from taking out a optical disc thrown in once in order to read and write the optical disc having recorded data on its front surface and back surface successively using a drive apparatus.

### SUMMARY OF INVENTION

### Technical Problem to be Solved

When data is migrated in a manner correlating a tape recording medium with different logical libraries, the technology disclosed in patent document 1 mentioned above goes no further than determining a logical library which has not performed ejection of the tape recording medium in the library apparatus as a target logical library of the migration destination of the data. In other words, the technology disclosed in patent document 1 does not give consideration to a recording medium thrown in from outside the library apparatus.

Also, the technology which patent document 2 mentioned above discloses does not have separated logical libraries, resources which are the subjects of exclusive control are a drive apparatus and a storage volume, and does no more than disclose a method to perform read and write from a plurality of hosts successively by queuing exclusion instructions. In other words, technology discloses in patent document 2 does not make consideration of correlating a recording medium thrown into a throw-in slot from outside to one of logical libraries.

Further, Even if general technologies disclosed in patent document 1 and patent document 2 mentioned above are combined, they do not disclose that, when a recording medium is thrown in from outside, operator's burden is reduced by making it easy to correlate a shared throw-in slot to a logical library of a throw in destination.

### SUMMARY

That is, the main purpose of the present invention is to provide a library apparatus and the like which correlate a shared throw-in slot into which a recording medium is thrown to an appropriate logical library easily in order to settle the problems mentioned above.

The present invention has been made for the purpose of solving the problems mentioned above.

That is, a library apparatus according to the present invention includes:

a slot shared when throwing a recording medium into the slot;

a logical library information including connection information of a logical library and an external apparatus connected to the logical library, the logical library packs a physical library storing the recording medium having been thrown in the slot based on a number, which is larger than a number of pieces of the slot accessible independently, and represents the packed each area of the physical library; and

a control unit to control so as the slot is correlated to the logical library; wherein

the control unit:

in case that import processing to take the recording medium into the external apparatus is directed, identifying, by referring to the logical library information, the logical library connected to the external apparatus which directed the import processing; and

correlating the slot having been thrown the recording medium to the identified logical library.

As another aspect of the present invention, a control method of a library apparatus according to the present invention, the library apparatus including

a slot shared when throwing a recording medium into the slot;

a logical library information including connection information of a logical library and an external apparatus connected to the logical library, the logical library packs a physical library storing the recording medium having been thrown in the slot based on a number, which is larger than a number of pieces of the slot accessible independently, and represents the packed each area of the physical library; and

a control unit to control so as the slot is correlated to the logical library;

by the control unit:

in case that import processing to take the recording medium into the external apparatus is directed, identifying, by referring to the logical library information, the logical library connected to the external apparatus which directed the import processing; and

correlating the slot having been thrown the recording medium to the identified logical library.

Meanwhile, this object is also achieved by a computer program which realizes a library apparatus and its control method mentioned above having the aforementioned configuration by a computer, and a non-transitory computer-readable storage medium in which the computer program is stored.

According to the present invention, a shared throw-in slot into which a recording medium has been thrown can be correlated to an appropriate logical library easily.

### BRIEF DESCRIPTION OF THE DRAWINGS

Exemplary features and advantages of the present invention will become apparent from the following detailed description when taken with the accompanying drawings in which:

FIG. 1 is a block diagram representing functions in a library apparatus according to a first exemplary embodiment of the present invention conceptually;

FIG. 2 is a block diagram exemplifying functions to correlate a logical library to an external apparatus in a library apparatus according to a second exemplary embodiment of the present invention;

FIG. 3 is a block diagram exemplifying functions in a library apparatus according to a third exemplary embodiment of the present invention;

FIG. 4 is a diagram representing a logical library connection information table in a library apparatus according to the second and third exemplary embodiments of the present invention notionally;

FIG. 5 is a diagram representing a logical library configuration information table in a library apparatus according to the third exemplary embodiment of the present invention notionally;

FIG. 6 is a diagram representing a logical library locking state table in a library apparatus according to the third exemplary embodiment of the present invention conceptually;

FIG. 7 is a flow chart illustrating Prevent cancellation processing in a library apparatus according to the third exemplary embodiment of the present invention;

FIG. 8 is a flow chart illustrating medium throw-in processing in a library apparatus according to the third exemplary embodiment of the present invention;

FIG. 9 is a flow chart illustrating medium transportation processing in a library apparatus according to the third exemplary embodiment of the present invention;

FIG. 10 is a block diagram illustrating an example in which a virtual external apparatus is used in a library apparatus according to an application of the third exemplary embodiment of the present invention;

FIG. 11 is a table illustrating relation between a virtual external apparatus number and an interface ID (identifier) in a library apparatus according to the application of the third exemplary embodiment of the present invention;

FIG. 12 is a table illustrating relation between a logical library number of a logical library of a connection object and a World_Wide_Name (WWN) in a virtual external apparatus in a library apparatus according to the application of the third exemplary embodiment of the present invention;

FIG. 13 is a block diagram exemplifying functions in a library apparatus according to a fourth exemplary embodiment of the present invention;

FIG. 14 is a flow chart illustrating READ_ELEMENT_STATUS command processing in a library apparatus according to the fourth exemplary embodiment of the present invention;

FIG. 15 is a flow chart illustrating exclusive Prevent cancellation processing which exclusively processes Import processing from a plurality of external apparatus in a library apparatus according to the fifth exemplary embodiment of the present invention; and

FIG. 16 is a block diagram illustrating a configuration when realizing functions in a library apparatus according to the sixth exemplary embodiment of the present invention by an information processing apparatus.

### EXEMPLARY EMBODIMENT

Hereinafter, the exemplary embodiments of the present invention will be described in detail with reference to drawings.

### First Exemplary Embodiment

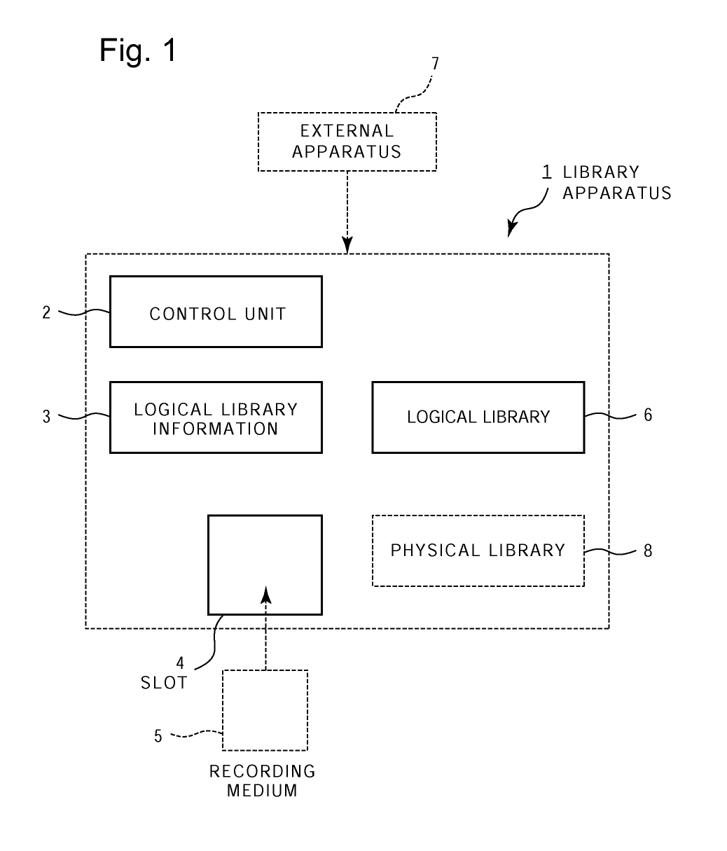

The configuration of a first exemplary embodiment of the present invention will be described. FIG. 1 is a block diagram representing functions in a library apparatus according to the first exemplary embodiment of the present invention conceptually.

A library apparatus 1 according to this exemplary embodiment includes a control unit 2, a logical library information 3, a throw-in slot 4 and a logical library 6. In general, a library apparatus includes one or more logical libraries. However, for the sake of simplified explanation, it is described that “the logical library 6” in this patent application, hereinafter.

A recording medium 5 is a computer-readable recording medium thrown (loaded) into the library apparatus 1. An external apparatus 7, which is connected to a logical library 6 possessed by the library apparatus 1, directs Import processing which is operation for taking in the recording medium 5 from the throw-in slot 4 into which the recording medium 5 is thrown.

A physical library 8 is a storage device having physical storage areas based on the recording medium 5 that has been thrown in, and the physical library 8 is separated and correlated to a plurality of pieces of logical library 6 that are logical storage areas.

That is, the library apparatus 1 according to this exemplary embodiment has: the throw-in slot 4 to be shared when the recording medium 5 is thrown in; the logical library 6 representing each of areas made by separating the physical library 8 storing the thrown-in recording medium 5 based on the number larger than the number of pieces of throw-in slot 4 that are accessible independently; the logical library information 3 including connection information with the external apparatus 7 connected to the logical library 6; and the control unit 2 to perform control so that the throw-in slot 4 into which the recording medium 5 have been thrown may be correlated to the logical library 6.

When Import processing (not illustrated: the same can be applied hereinafter) for taking the recording medium 5 having been thrown into the throw-in slot 4 in the external apparatus 7 is directed, the control unit 2 in the library apparatus 1 according to this exemplary embodiment identifies the logical library 6 that is connected to the external apparatus 7 directing the Import processing by referring to the logical library information 3, and correlates the throw-in slot 4 into which the recording medium 5 has been thrown to the identified logical library 6.

As a result, according to the Import processing performed by the external apparatus 7, the library apparatus 1 according to this exemplary embodiment can correlate the throw-in slot 4 into which an operator (not shown) operating this library apparatus 1 has thrown the recording medium 5 and the logical library 6 easily by referring to the logical library information 3. Consequently, according to this exemplary embodiment, a burden when the operator operates the library apparatus 1 can be reduced.

Also, the external apparatus 7 can thereby read and write information recorded in the recording medium 5 appropriately through the logical library 6 correlated to the recording medium 5.

The reason of this is that, according to this exemplary embodiment, because the logical library 6 that is logically connected with the external apparatus 7 that has performed Import processing is identified taking the Import processing as an opportunity, and the shared throw-in slot 4 into which the recording medium 5 has been thrown is correlated to the identified logical library 6, an operator does not have to perform operation for such as designating the logical library 6 which is the destination of the throwing-in of the recording medium 5, a logical throw-in slot (not shown) mentioned later which is a logical throw-in port and the like further provided in the logical library 6 from a manual operating panel or the like.

That is, according to the first exemplary embodiment, a shared throw-in slot into which the recording medium has been thrown can be correlated to the appropriate logical library easily.

Meanwhile, in FIG. 1, an example in which the library apparatus 1 includes the physical library 8 is indicated. However, the library apparatus 1 and the physical library 8 may be of separate bodies.

The physical library 8 has been explained using a configuration in which the physical library 8 is separated based on the number larger than the number of pieces of throw-in slot 4 that are accessible independently, and each of the grouped areas represents the logical library 6. Here, the word “to separate” can be also understood as, when a plurality of physical libraries that exist physically are treated as a large set, for example, dividing it into a plurality of small sets (in other words, dividing it into groups, or grouping it or separating it).

Although the first exemplary embodiment of the present invention has been described taking the aforementioned configuration and the operations as a example above, the present invention described taking this exemplary embodiment as an example is not limited to such configuration and operation.

### Second Exemplary Embodiment

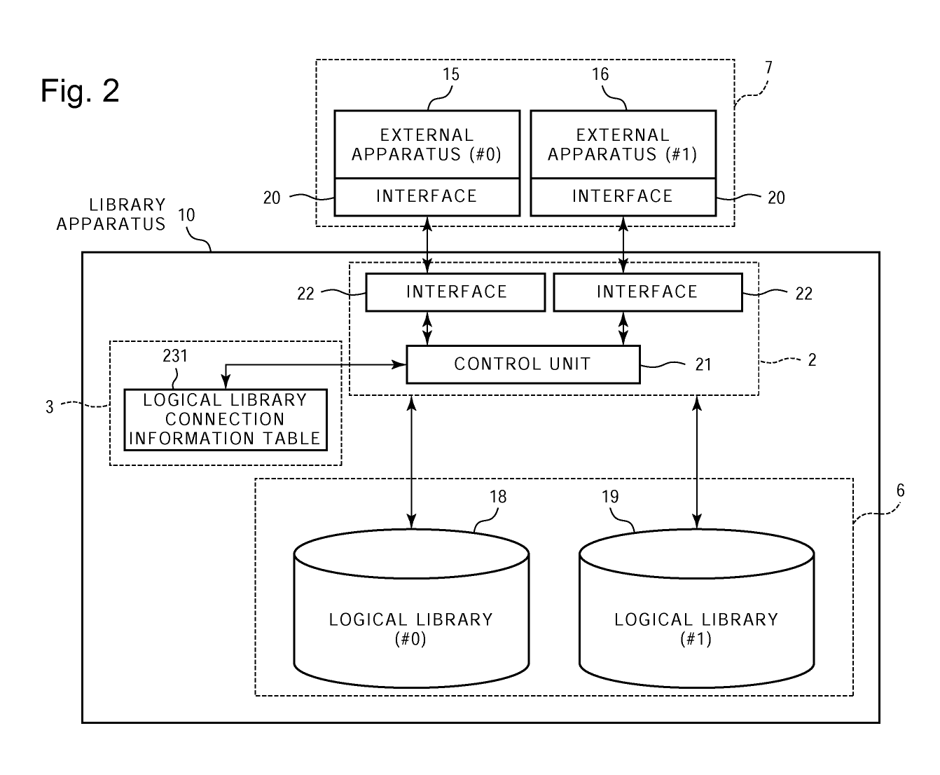

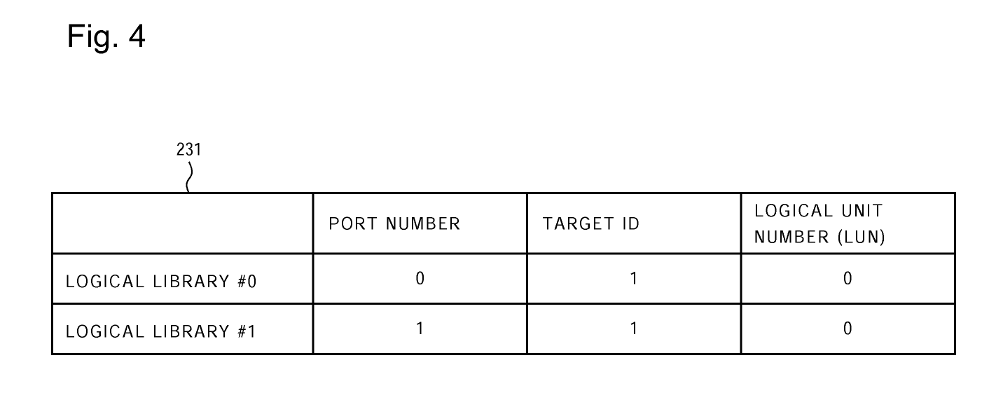

Next, the second exemplary embodiment based on the first exemplary embodiment will be described with reference to FIG. 2 and FIG. 4.

FIG. 2 is a block diagram exemplifying a function to correlate the logical library 6 to the external apparatus 7 in a library apparatus 10 according to the second exemplary embodiment.

In the following explanation, description will be made centering on characteristic parts of this exemplary embodiment, and overlapped description will be omitted about the same structures as the first exemplary embodiment mentioned above by attaching the identical reference numbers.

The configuration in the library apparatus 10 according to this exemplary embodiment includes a control unit 2, a logical library information 3 including a logical library connection information table 231 and a logical library 6. The library apparatus 10 is connected with an external apparatus 7 so as to be able to communicate each other.

The control unit 2 in the library apparatus 10 has a control unit 21 and an interface 22. The logical library connection information table 231 is a table for determining a logical library in the library apparatus 10 to be a connection target based on directions from the external apparatus 7.

The logical library 6 has a logical library (#0) 18 and a logical library (#1) 19. The external apparatus 7 has an external apparatus (#0) 15, an external apparatus (#1) 16 and an interface 20.

Meanwhile, the external apparatus (#0) 15, the external apparatus (#1) 16 and the interface 20 in the library apparatus 10 according to this exemplary embodiment correspond to the external apparatus 7 described in the first exemplary embodiment. The control unit 21 and the interface 22 in the library apparatus 10 corresponds to the control unit 2 in the first exemplary embodiment. The logical library (#0) 18 and the logical library (#1) 19 in the library apparatus 10 corresponds to the logical library 6 in the first exemplary embodiment.

When each of a plurality of logical libraries or a plurality of external apparatus is distinguished, symbols of (#0) and (#1) which represent the respective numbers may be used. When a plurality of logical libraries or a plurality of external apparatus are collectively called, they may be called respectively the logical library 6 and the external apparatus 7 (the same can be applied below).

In this exemplary embodiment, for convenience of explanation, a case where there exist the external apparatus 15 and 16, two pieces of interface 20, two pieces of interface 22 and the logical libraries 18 and 19 will be described as an example. However, the numbers of external apparatus, interfaces and logical libraries are not limited to the numbers mentioned above.

FIG. 4 is a diagram representing the logical library connection information table 231 in the library apparatus 10 according to this exemplary embodiment conceptually.

When a command for performing Import processing issued by the external apparatus 7 when performing Import processing for taking in a recording medium (not shown) is received via the interface 22, for example, the control unit 21 identifies to which logical library which external apparatus is going to perform Import processing using the logical library connection information table 231 shown in FIG. 4.

Specifically, the logical library connection information table 231 shown in FIG. 4 possesses in a associated manner: a port (Port) number representing a port provided in the interface 22 in the library apparatus 10 that has accepted a command from the external apparatus 7; a target (Target) ID (Identification: hereinafter, it may be called “an identifier”) for identifying a logical library connected to the port logically; and a logical unit number (Logical_Unit_Number: hereinafter, it may be abbreviates as “LUN”) that a logical library has.

Using these numbers and identifiers, the logical library connection information table 231 can express (identify) a logical library number representing the logical libraries 18 and 19 with which the external apparatus 15 and 16 are connected, respectively.

That is, according to the second exemplary embodiment, taking a command that an external apparatus issues as an opportunity, in an interface in a library apparatus which has received the command, a logical library of an appropriate connection destination to be connected to the external apparatus can be determined easily.

Although description of the second exemplary embodiment of the present invention has been made taking the aforementioned configuration and the operations as an example above, the present invention described taking this exemplary embodiment as an example is not limited to such configuration and operations.

### Third Exemplary Embodiment

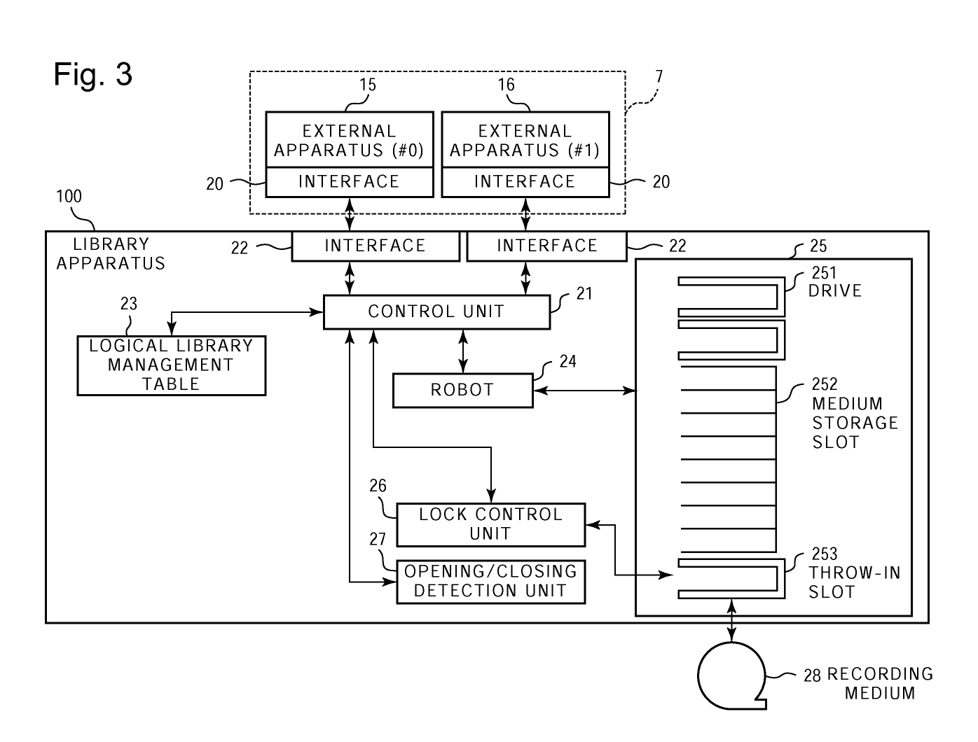

Next, the third exemplary embodiment based on the first and second exemplary embodiments will be described with reference to FIGS. 3 to 9. FIG. 3 is a block diagram exemplifying functions in a library apparatus 100 according to this exemplary embodiment.

A configuration in the library apparatus 100 according to this exemplary embodiment includes a control unit 21, a interface 22, a logical library management table 23, a robot (transport device) 24, a slot 25, a lock control unit 26 and an opening/closing detection unit 27.

The slot 25 includes a drive 251 which reads and writes data recorded in a recording medium 28 that has been transported, a medium storage slot 252 which stores the recording medium 28, and a throw-in slot 253 for throwing the recording medium 28 into the library apparatus 100.

Meanwhile, because Import processing is performed by a plurality of external apparatus, the throw-in slot 253 may be called a “shared throw-in slot” 253 (the same can be applied hereinafter).

The control unit 2, the logical library information 3 and the throw-in slot 4 that are provided in the library apparatus 1 in the first exemplary embodiment correspond to the control unit 21 and the interface 22, the logical library management table 23 and a throw-in slot 253 that are provided in the library apparatus 100 in this exemplary embodiment, respectively in this order.

The library apparatus 100 according to this exemplary embodiment is different from the first and second exemplary embodiments in a point that it further includes the robot 24, the slot 25, the lock control unit 26 and the opening/closing detection unit 27.

Accordingly, in the following explanation, description will be made centering on a characteristic parts of this exemplary embodiment, and overlapped description will be omitted about the same structures as the first and second exemplary embodiments mentioned above by attaching the identical reference numbers.

Meanwhile, a drive apparatus which reads and writes data stored in the recording medium 28 is just called the drive 251.

Referring to FIG. 3, by receiving a command from the external apparatus 15 or 16, the library apparatus 100 performs processing to import the recording medium 28 in the library apparatus 100 (that is, the recording medium 28 is taken in the external apparatus 7) and conveys the recording medium 28. Then, the library apparatus 100 notifies the external apparatus 15 or 16 of a result of this.

Meanwhile, when the external apparatus 15 and 16 are expressed, it may be collectively called the external apparatus 7. When the external apparatus 15 or 16 is represented, it may be called one of external apparatus 7.

The external apparatus 7 issues a command to the library apparatus 100 that is connected so as to be able to communicate via the interface 20 provided in the external apparatus 7, and the library apparatus 100 receives the command issued from the external apparatus 7 via the interface 22 in the library apparatus 100.

The library apparatus 100 according to this exemplary embodiment will be described taking a case where there are two sets of the external apparatus, the interface 20 and the interface 22 as an example for convenience of explanation. However, the number of pieces of the external apparatus and the number of interfaces are not limited to this number (the same can be applied hereinafter).

Also, the library apparatus 100 has: the control unit 21 that controls the library apparatus 100 according to the content of a command received from the external apparatus 7; and the logical library management table 23 that holds information for separating resources such as the drive 251 and the medium storage slot 252 in the slot 25 provided in the library apparatus 100, and correlating them with a logical library (not illustrated: the same can be applied hereinafter) corresponding to each of them.

The library apparatus 100 also has the robot 24 that conveys the recording medium 28 stored in the library apparatus 100.

The library apparatus 100 further has the lock control unit 26 that locks the throw-in slot 253, which is accessible from both the side of the robot 24 that conveys the recording medium 28 and the side of an operator that performs operation for taking in and out the recording medium 28, in order not to be accessed from the operator side; and the opening/closing detection unit 27 that detects an operator opening or shutting a throw-in port in the throw-in slot 253 in order to throw the recording medium 28 into the throw-in slot 253.

Meanwhile, the control unit 21 has a control program (not shown) including firmware (Firm_Ware: hereinafter, it is abbreviated as “FW”) or the like, for example, which controls the library apparatus 100 itself.

Also, Application (application: it is abbreviated as “AP” hereinafter) _SoftWare (software: it is abbreviated as “SW” hereinafter, and may be abbreviated as “AP_SW” hereinafter) which operates in the external apparatus 7 can make a scanner device or the like (not illustrated) provided in the robot 24 read information on the recording medium 28 stored in the medium storage slot 252, such as a barcode attached to the recording medium 28, and report the read data to the external apparatus 7.

Meanwhile, information such as a barcode mentioned above represents presence or absence of a bar code label stuck on the recording medium 28 and data or the like obtained by reading a bar code label name, for example (the same can be applied hereinafter).

Next, information which the logical library management table 23 holds will be described using tables shown in FIGS. 4 to 6. FIGS. 4 to 6 show a logical library connection information table 231, a logical library configuration information table 232 and a logical library locking state table 233 provided in the logical library management table 23 in turn.

The logical library connection information table 231 shown in FIG. 4 is a table showing a corresponding relationship between a logical library to be correlated to the external apparatus 7 logically and a logical library number representing the number of the logical library.

The logical library connection information table 231 expresses a logical library number using a port number in the interface 22, a target identifier (ID) and a logical unit number (LUN). Because this has been described in the second exemplary embodiment, description in this exemplary embodiment will be omitted.

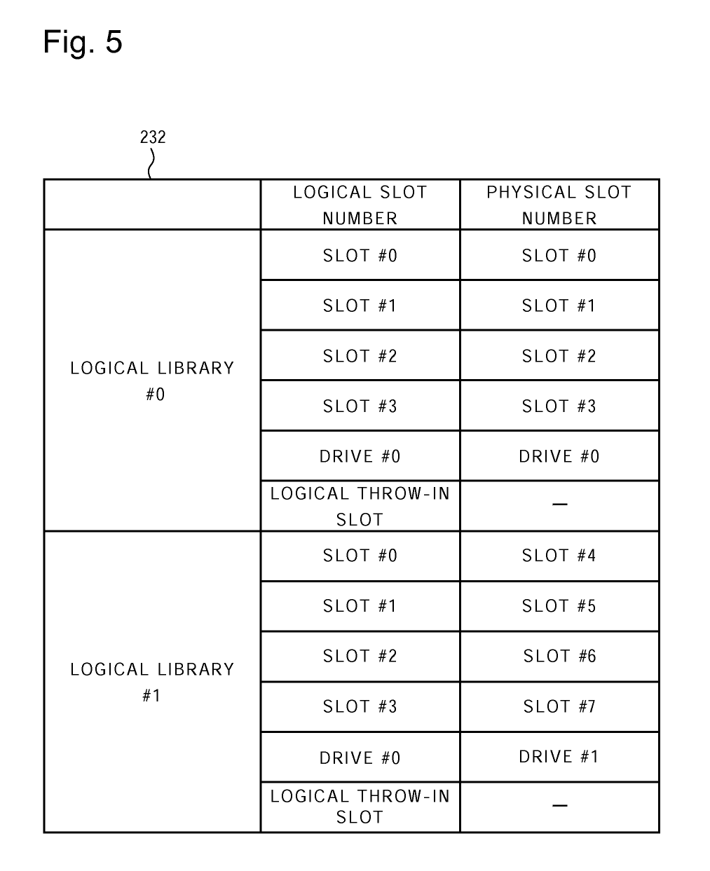

Next, the logical library configuration information table 232 shown in FIG. 5 distinguishes logical libraries which have been correlated to a separated physical library in the library apparatus 100 by attaching a logical library number to them. The logical library configuration information table 232 is a table expressing a corresponding relationship between a logical slot number representing a logical slot forming a logical library, and a physical slot number representing a physical slot forming a physical library. That is, FIG. 5 is a diagram showing the logical library configuration information table 232 in the library apparatus 100 according to this exemplary embodiment conceptually.

The external apparatus 7 can access, through each correlated logical library, the drive 251 and the medium storage slot 252 that are respective separated physical resources in the slot 25 (in other words, the physical library (not shown)).

Here, logical slot numbers in logical library #1, for example, shown in FIG. 5 are recognized as, seen from the external apparatus 16 (#1), there are logical slot numbers of #0 to #3 which express logical slots corresponding to separated physical slots. In other words, as an example, logical slot number #0 of the logical slots belonging to logical library #1 in FIG. 5 corresponds to physical slot number #4of the physical slots.

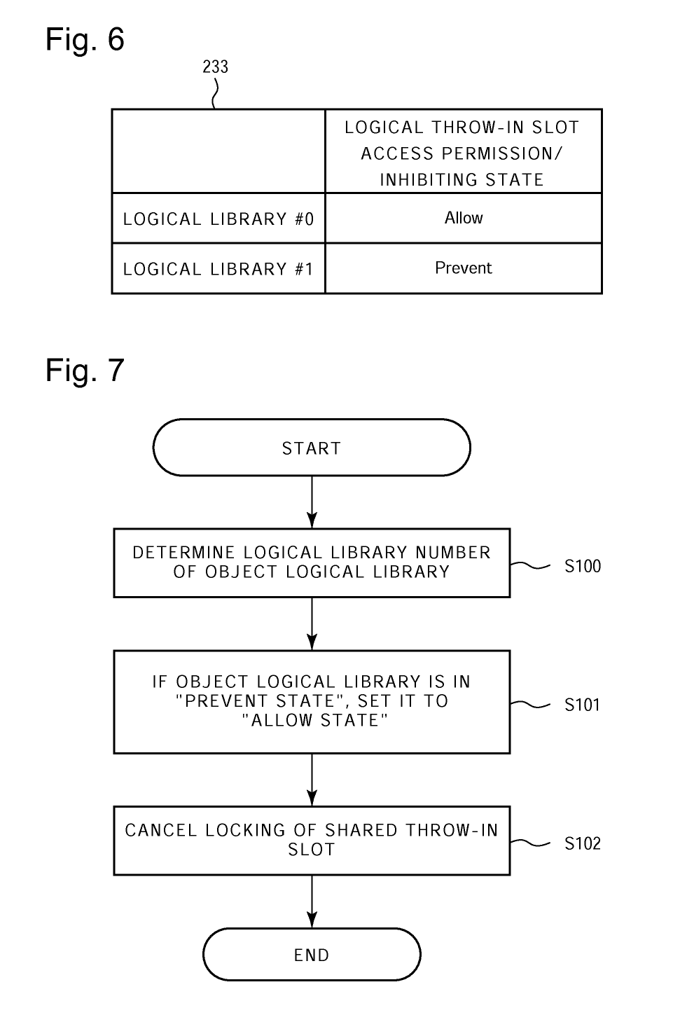

Next, the logical library locking state table 233 shown in FIG. 6 is a table that indicates whether it is a state in which taking in and out (hereinafter, it may be called access: the same can be applied hereinafter) the recording medium 28 to and from the throw-in slot 253 correlated to one of the logical libraries from outside is inhibited (hereinafter, it is also transcribed as “Prevent state”), or is a state it is permitted (hereinafter, it is also transcribed as “Allow state”).

In other words, FIG. 6 is a diagram showing the logical library locking state table 233 in the library apparatus 100 according to this exemplary embodiment conceptually.

The control unit 21 receives a “PREVENT_ALLOW_MEDIUM_REMOVAL” command, for example, issued from the external apparatus 7, and inhibits or permits taking in and out of the recording medium 28 to and from the throw-in slot 253 based on the received command.

The logical library locking state table 233 shown in FIG. 6 indicates, as a table for providing explanation as an example in this exemplary embodiment, only information on whether each logical library is in “Prevent state” or in “Allow state”.

However, regarding access (taking in and out) of the recording medium 28 to the shared throw-in slot 253, management of a state in which access is inhibited or a state in which it is permitted is performed for each one of external apparatus 7 connected to each of the logical libraries, and, in addition, when access from any one of the external apparatus 7 is inhibited, the shared throw-in slot 253 will be in a state where operation from outside for taking in/out a medium is inhibited.

Meanwhile, the “PREVENT_ALLOW_MEDIUM_REMOVAL” command that the external apparatus 7 issues as an example mentioned above is described in detail in Small_Computer_Serial_Interface (hereinafter, it is abbreviated as “SCSI”) _Medium_Changer_Commands-3 (hereinafter, it is abbreviated as “SMC-3”) described by INCITS_Technical_Committee_T10 which specifies command standards in an external apparatus which controls the library apparatus 100.

Therefore, the detailed description about the “PREVENT_ALLOW_MEDIUM_REMOVAL” command here will be omitted.

Further, INCITS is an abbreviation of International_Committee_for_Information_Technology_Standards. The T10 mentioned above is one of technical committees which establish technical standards related to SCSI in INCITS.

Next, operations in the library apparatus 100 according to this exemplary embodiment will be described.

A method to correlate the throw-in slot 253 to a logical library using a locking state of the logical library in this exemplary embodiment will be described in detail using the block diagram shown in FIG. 3, the tables shown in FIGS. 4 to 6 and the flow charts shown in FIGS. 7 to 9.

As mentioned above, when accessing the library apparatus 100, AP_SW which operates in the external apparatus 7 sets, in order to prevent the recording medium 28 from being taken out from or thrown into the library apparatus 100, the library apparatus 100 to “Prevent state” by issuing a “PREVENT_ALLOW_MEDIUM_REMOVAL” command, for example.

Then, the control unit 21 in the library apparatus 100 makes the library apparatus 100 be in “Allow state” only when Import processing is performed, so as to make it possible to take out and throw the recording medium 28 from and into the library apparatus 100 temporarily by issuing a “PREVENT_ALLOW_MEDIUM_REMOVAL” command.

The flow chart shown in FIG. 7 indicates processing when issuing a “PREVENT_ALLOW_MEDIUM_REMOVAL” command in order to set “Allow state” (in other words, a Prevent cancellation state) in which an operator can throw the recording medium 28 into the throw-in slot 253 to be associated with a logical library to which one of external apparatus 7 corresponds.

That is, FIG. 7 is a flow chart illustrating Prevent cancellation processing in the library apparatus 100 according to this exemplary embodiment.

Referring to the flow chart shown in FIG. 7, when a “PREVENT_ALLOW_MEDIUM_REMOVAL” command is issued from one of external apparatus 7 (in other words, the external apparatus (#0) 15 or the external apparatus (#1) 16: the same can be applied hereinafter) first, the control unit 21 receives the command via the interface 22 and begins processing for cancelling “Prevent state”.

Then, the control unit 21 refers to the logical library connection information table 231 (FIG. 4), and determines a corresponding logical library number by comparing a port number about the interface 22 that has received the command, a target ID (identifier) and a logical unit number (LUN) with the contents of the logical library connection information table 231 (Step S100).

Next, the control unit 21 refers to the logical library locking state table 233 (FIG. 6), and, when an access permission state or an access inhibiting state to the throw-in slot 253 to be correlated to a logical library to be a target of connection with one of external apparatus 7 that has issued the command is “Prevent state” (inhibiting state), sets it to “Allow state” (permission state) (Step S101).

Then, the control unit 21 controls the lock control unit 26 to cancel locking of the throw-in slot 253 (Step S102).

When locking of the throw-in slot 253 is canceled, an operator opens the throw-in port in order to throw the recording medium 28 into the library apparatus 100, throws the recording medium 28 into the throw-in slot 253 and then closes the throw-in port.

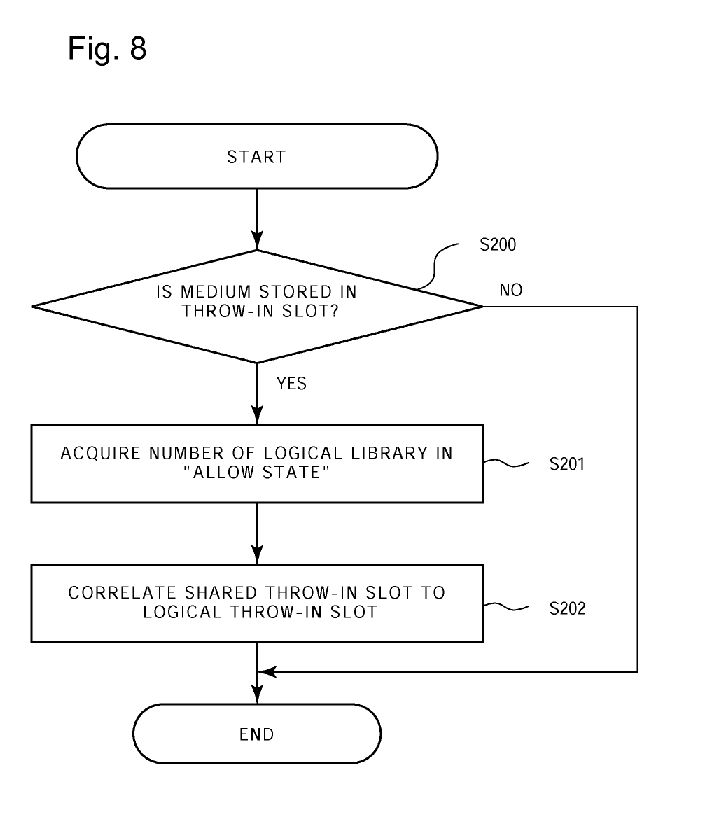

When the control unit 21 in the library apparatus 100 detects that the throw-in port in the throw-in slot 253 has been closed by the opening/closing detection unit 27, the control unit 21 begins medium throw-in processing shown in FIG. 8 mentioned later.

Meanwhile, when a command is issued from a plurality of external apparatus, for example, it should be treated in order of arrival in the control unit 21.

After an operator has thrown the recording medium 28 into the throw-in port, AP_SW operating in the external apparatus 7 may issue a re-locking request for locking the throw-in port again, for example, to the library apparatus 100. In that case, the control unit 21 that has received the re-locking request locks the throw-in port of the throw-in slot 253 by the lock control unit 26.

Logical libraries corresponding to the external apparatus 7, respectively, have a logical throw-in slot (that is, a virtual throw-in slot: not shown: the same can be applied hereinafter) for throwing the recording medium 28 into a logical library thrown logically, respectively. Therefore, there is a case where a destination to be correlated with the throw-in slot 253 into which the recording medium 28 has been thrown is represented as a logical throw-in slot provided in the logical library.

FIG. 8 is a flow chart illustrating medium throw-in processing in the library apparatus 100 according to this exemplary embodiment.

In medium throw-in processing shown in FIG. 8, the control unit 21 in the library apparatus 100 confirms whether the recording medium 28 is stored in the throw-in slot 253 (Step S200).

When the recording medium 28 is stored (YES, at Step S200), the control unit 21 refers to the locking state table 233 (FIG. 6) illustrating a permission state of access or an inhibiting state of access to the throw-in slot 253 to be correlated with the logical throw-in slot provided in a logical library, and acquires the number of a logical library (in other words, logical library number) whose access permission state to the throw-in slot 253 is “Allow state” (Step S201).

Then, the control unit 21 refers to the logical library configuration information table 232 (FIG. 5), correlates the throw-in slot 253 to a logical throw-in slot which is a logical throw-in port for throwing the recording medium in a logical slot corresponding to a logical library number (Step S202), and ends the processing for throwing in the recording medium 28.

When the recording medium 28 is not stored in the throw-in slot 253 (NO, at Step S200), the control unit 21 does not correlate the throw-in slot 253 to the logical throw-in slot in the logical library number and ends the medium throw in processing without doing anything.

When an operator throws the recording medium 28 into the library apparatus 100, and it becomes a state that the recording medium 28 is stored in a state that the throw-in slot to be shared is logically correlated to the logic throw-in slot provided in the logical library of the object, AP-SW which operates in the external apparatus 7 confirms the recording medium 28 thrown in the shared throw-in slot 253. Then, the control unit 21 conveys the recording medium 28 to the medium storage slot 252 from the throw-in slot 253 in the slot 25 using the robot 24.

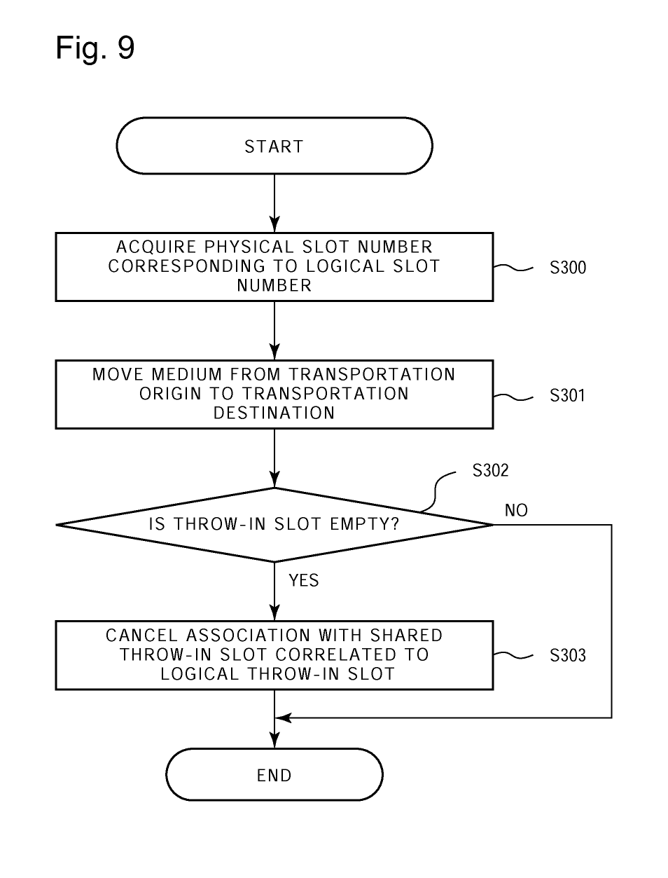

FIG. 9 is a flow chart illustrating medium transportation processing in the library apparatus 100 according to this exemplary embodiment.

The medium transportation processing shown in FIG. 9 represents processing in the library apparatus 100 when external apparatus 7 has issued a “MOVE_MEDIUM” command that directs transportation of the recording medium 28 in the library apparatus 100.

In the medium transportation processing shown in FIG. 9, the control unit 21 in the library apparatus 100 acquires physical slot numbers corresponding to logical slot numbers representing the origin and destination of transportation which have been designated by AP_SW operating in the external apparatus 7 with reference to the logical library configuration information table 232 (Step S300).

Next, using the robot 24, the control unit 21 moves the recording medium 28 from a physical slot indicated by the physical slot number designated as the origin of transportation to a physical slot indicated by a different physical slot number designated as the transportation destination (Step S301).

After that, the control unit 21 checks whether the throw-in slot 253 is in the empty state or not (Step S302).

When the recording medium 28 is not stored in the throw-in slot 253 (YES, at Step S302), the control unit 21 refers to the logical library configuration information table 232 and cancels the association of the logical throw-in slot provided in the logical library which is the logical throw-in port and the throw-in slot 253 (Step S303).

When the recording medium 28 is still stored in the throw-in slot 253 after the recording medium transportation (NO, at Step S302), without canceling association of the logical throw-in slot provided in the logical library which is the object of correlation and the throw-in slot 253 mentioned above, the control unit 21 ends medium transportation processing.

By carrying out the Prevent cancellation processing (FIG. 7), the medium throw-in processing (FIG. 8) and the medium transportation processing (FIG. 9) mentioned above, the control unit 21 in the library apparatus 100 can automatically correlate the shared throw-in slot 253 into which the recording medium 28 has been thrown to the logical throw-in slot provided in a logical library of the object of access by the external apparatus 7.

The reason of this is that, in a protocol used between the external apparatus 7 and the library apparatus 100 (such as a “PREVENT_ALLOW_MEDIUM_REMOVAL” command specified in SMC-3, for example), the control unit 21 is carried out, taking a command issued by the external apparatus 7 as an opportunity, based on information to which logical library the command has been issued.

In addition, this exemplary embodiment is based on the first and second exemplary embodiments. Therefore, this exemplary embodiment has the effects provided by the first and second exemplary embodiments similarly.

In other words, according to the third exemplary embodiment, a shared throw-in slot into which a recording medium has been thrown can be correlated to an appropriate logical library easily.

Meanwhile, in this exemplary embodiment, for convenience of explanation, description has been made taking a case where the number of pieces of the throw-in slot 253 is one as an example. However, the number of pieces of the throw-in slot 253 is not limited to this number.

Although the third exemplary embodiment of the present invention has been described taking the aforementioned configuration and the operation as an example above, the present invention described taking this exemplary embodiment as an example is not limited to such configuration and operation.

(Application of the Third Exemplary Embodiment)

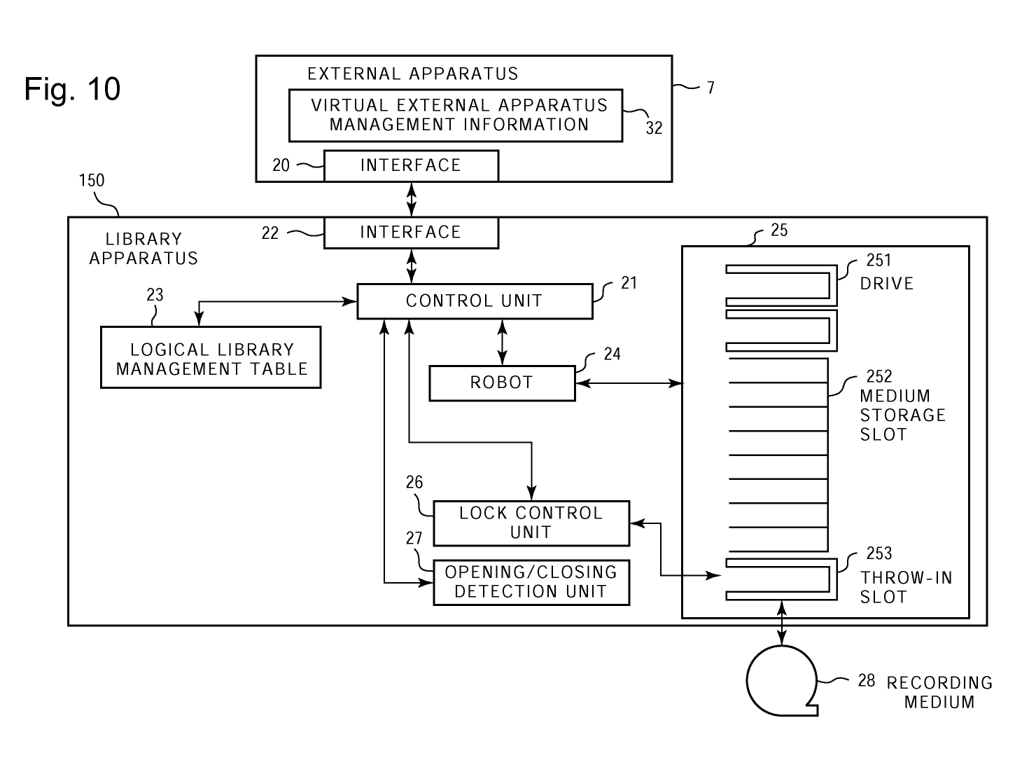

Next, an application in the third exemplary embodiment based on the first to third exemplary embodiments will be described in detail with reference to FIGS. 4 to 12. FIG. 10 is a block diagram illustrating an example in which a virtual external apparatus is used in a library apparatus 150 according to an application of this exemplary embodiment.

It is supposed that the library apparatus 150 according to the application of this exemplary embodiment uses a plurality of virtual external apparatus which is a virtualized version of the external apparatus 7 in the third exemplary embodiment.

The virtualized external apparatus 7 differs from the library apparatus 1, 10 and 100 in the first to third exemplary embodiments in a point that, by using virtual external apparatus management information 32, it is made to be seen from outside (that is, the library apparatus) as a plurality of external apparatus.

Accordingly, in the following description, description will be made centering on characteristic parts of this exemplary embodiment, and overlapped description is omitted about the same configurations as the first to third exemplary embodiments mentioned above by attaching the identical reference numbers.

Meanwhile, in the application of this exemplary embodiment, the external apparatus 7 has a plurality of virtualized virtual external apparatus in it, and a case where each of the virtual external apparatus is connected logically with the library apparatus 150 via the interface 20 provided in the external apparatus 7, and a case further including a plurality of virtualized external apparatus 7 are also included in the application.

Also, the application in this exemplary embodiment is applicable to a case where pieces of interface 20 provided in a plurality of external apparatus 7 having a plurality of virtual external apparatus are concentrated in a single fiber channel via Fibre_Channel_Switch (Fibre_Channel_Switch: hereinafter, it is abbreviated as “FC switch”) which is not illustrated, for example, and the FC is connected to the single interface 22, for example, in the library apparatus 150, Here, line concentration by a FC switch mentioned above is an example, and the present invention is not limited to a method mentioned above.

Moreover, without being limited to a virtualized external apparatus mentioned above, the library apparatus 150 according to the application of this exemplary embodiment is applicable in a case of a redundant configuration where a plurality of pieces of interface 20 are provided in a single physical external apparatus 7, for example, and the respective pieces of interface 20 are connected with a plurality of pieces of interface 22 (not shown) in the library apparatus 150, respectively.

In other words, the library apparatus 150 according to the application of this exemplary embodiment can realize an exemplary embodiment including the cases mentioned above in which a logical connection corresponding to a physical connection structure between the external apparatus 7 and the library apparatus 150 cannot be correlated uniquely.

In the application of this exemplary embodiment, for convenience of explanation, a case where the external apparatus 7 connected to the single interface 22 is used as a plurality of virtual external apparatus will be described as an example.

Although the internal configuration of the library apparatus 150 shown in FIG. 10 is the same as that of the third exemplary embodiment, it is different from the third exemplary embodiment in a point that it has the single interface 22 as an example, and in a point that it has a virtual external apparatus identification table 121 included in the virtual external apparatus management information 32, and a logical library virtual external apparatus table 234 included in the logical library management table 23.

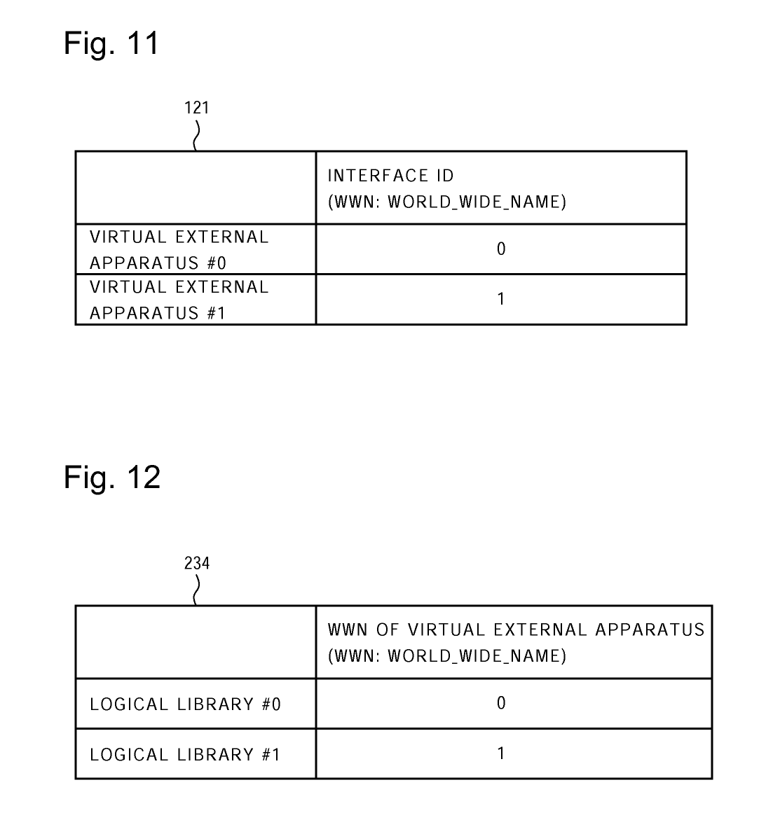

World_Wide_Name (that is, an identifier for identifying a device specified in the Strage_Area_Network (it is abbreviated as “SAN” hereinafter) standard: hereinafter, it is abbreviated as “WWN”) in FIG. 11 and FIG. 12 correlates a virtual external apparatus number in the external apparatus 7 and a logical library number in the library apparatus 150.

That is, FIG. 11 is the virtual external apparatus identification table 121 representing relation between a virtual external apparatus number and an interface ID (that is, WWN which is an identifier: the same can be applied hereinafter) in a virtual external apparatus according to the application of this exemplary embodiment.

FIG. 12 is the logical library virtual external apparatus table 234 representing relation between a logical library number of a logical library of a connection object in the library apparatus 150 and WWN in a virtual external apparatus according to the application of this exemplary embodiment.

The external apparatus 7 is a single external apparatus physically. However, the external apparatus 7 has a plurality of virtual external apparatus (not shown: the same can be applied hereinafter) and the virtual external apparatus management information 32 that holds management information on these virtual external apparatus inside.

Connection from each virtual external apparatus to each logical library of a connection object in the library apparatus 150 is made via the interface 20 in the external apparatus 7 logically, respectively.

When accessing a logical library of a connection object, a virtual external apparatus uses an interface ID (WWN) indicated in the virtual external apparatus identification table 121 shown in FIG. 11 provided in the virtual external apparatus management information 32 as an identifier in the interface 20.

Then, the control unit 21 in the library apparatus 150 corresponds a virtual external apparatus number (in other words, virtual external apparatus #0 and #1) and an interface ID (WWN) shown in FIG. 11, and a logical library number shown in FIG. 12 to which the virtual external apparatus connects, and thus can associate the virtual external apparatus and the logical library.

Meanwhile, in the application of this exemplary embodiment, although WWN is used as a method for discriminating virtual external apparatus as an example, it is not limited to WWN if it is information which can associate a virtual external apparatus to be used and a logical library of a connection object uniquely.

Next, based on a flow chart shown in FIG. 7 illustrating Prevent cancellation processing having been used in the description of the third exemplary embodiment, operations in which a virtual external apparatus performs Import processing of the recording medium 28 will be described.

When a virtual external apparatus issues a “PREVENT_ALLOW_MEDIUM_REMOVAL” command for making the shift to “Allow state” which enables to throw the recording medium 28 into the shared throw-in slot 253 temporarily, the control unit 21 receives the command and begins processing to cancel “Prevent state”.

In the Prevent state cancelling processing, first, the control unit 21 refers to the logical library virtual external apparatus table 234 in the logical library management table 23 shown in FIG. 12, and determines a logical library number of a logical library having been correlated to the WWN of the virtual external apparatus which is the issuer of the command (Step S100).

When the logical library which is the connection target is in “Prevent state”, the control unit 21 sets it to “Allow state” (Step S101), and cancels locking of the throw-in slot 253 (Step S102).

In other words, when the external apparatus 7 is a virtual external apparatus, the Prevent cancellation processing shown in FIG. 7 used in the third exemplary embodiment can perform Import processing, for example, by referring to the virtual external apparatus identification table 121 and the logical library virtual external apparatus table 234.

Accordingly, because afterward processing that an operator throws the recording medium 28 into the shared throw-in slot 253, that the control unit 21 detects opening and shutting of a throw-in port by the opening/closing detection unit 27 and carries out medium throw-in processing (FIG. 8) and medium transportation processing (FIG. 9) is similar to those of the third exemplary embodiment, description will be omitted.

As mentioned above, even when the external apparatus 7 includes a plurality of virtual external apparatus, and the external apparatus 7 cannot be distinguished uniquely from a physical connection structure, such as in a case where virtual external apparatus are connected to a logical libraries logically, respectively, the application of this exemplary embodiment can correlate the throw-in slot 253 of common use into which the recording medium 28 has been thrown to a logical throw-in slot possessed by a logical library of an appropriate connection destination using the virtual external apparatus identification table 121 and the logical library virtual external apparatus table 234.

Meanwhile, in this exemplary embodiment, a case where the external apparatus 7 connected to the single interface 22 is used as a plurality of virtual external apparatus has been described as an example.

However, the same effect as this exemplary embodiment mentioned above can be produced even in a case where a plurality of pieces of virtualized external apparatus 7 mentioned above are provided further, and a case where pieces of interface 20 provided in a plurality of pieces of virtualized external apparatus 7 are concentrated into a single FC via FC switches, and the FC is connected to the single interface 22 in the library apparatus.

That is, the library apparatus 150 according to the application of this exemplary embodiment can be applied to cases including a case where a physical connection structure and logical library cannot be correlated uniquely. As a result, the same effect as the third exemplary embodiment can be obtained.

In other words, according to the application of the third exemplary embodiment, even when a logical interface is used between an external apparatus and a library apparatus, a shared throw-in slot into which a recording medium has been thrown can be correlated to an appropriate logical library easily.

Although description has been made taking the configuration and the operations as an application example in the third exemplary embodiment of the present invention above, the present invention described taking this exemplary embodiment as example is not limited to the configuration and the operations.

### Fourth Exemplary Embodiment

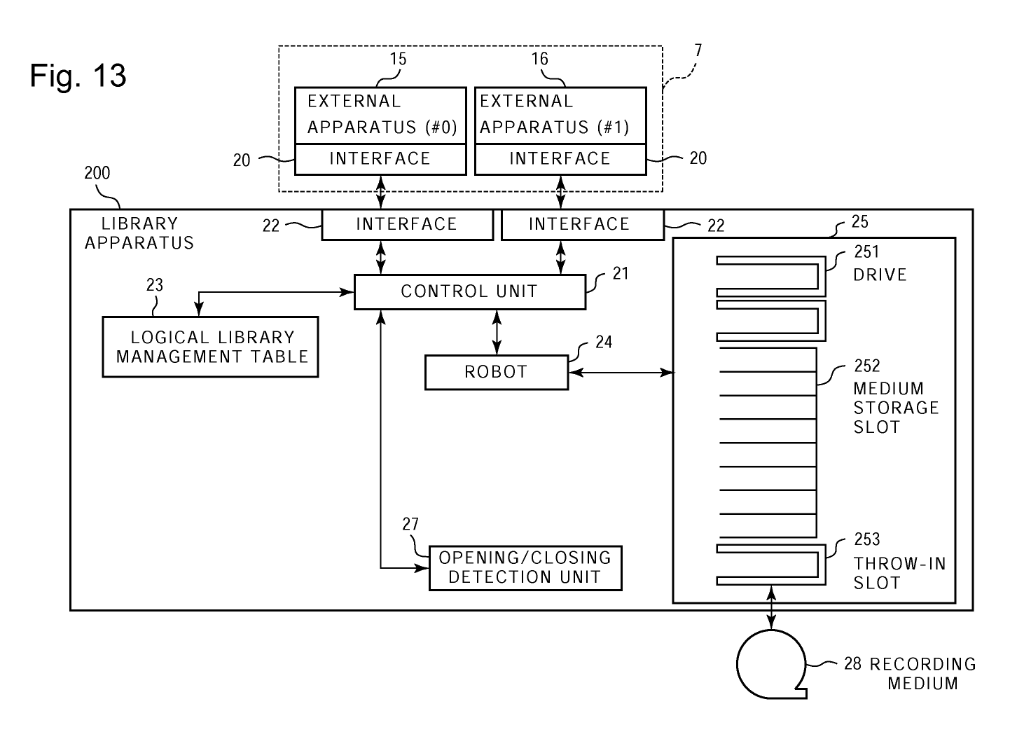

Next, the fourth exemplary embodiment based on the first to third exemplary embodiments will be described with reference to FIGS. 4 and 5, FIG. 13 and FIG. 14. FIG. 13 is a block diagram representing functions in a library apparatus 200 according to this exemplary embodiment conceptually.

The library apparatus 200 according to this exemplary embodiment differs from the third exemplary embodiment in a point that it is not equipped with the lock control unit 26 and the logical library locking state table 233 (FIG. 6) provided in the logical library management table 23 in the library apparatus 100 according to the third exemplary embodiment.

Therefore, also different is a point that AP_SW which operates in the external apparatus 7 issues a command different from the command described in the third exemplary embodiment to a library apparatus of a structure which always leaves the throw-in port in the shared throw-in slot 253 unlocked.

Accordingly, in the following description, description will be made centering on characteristic parts of this exemplary embodiment, and overlapped description is omitted about the same structures as the first to third exemplary embodiments mentioned above by attaching the identical reference numbers.

In other words, it is premised that the library apparatus 200 according to this exemplary embodiment is used in a state that taking out the recording medium 28 to outside from the library apparatus 200 and throwing in the recording medium 28 from outside is not inhibited, and the throw-in slot 253 is always accessible from an operator.

When an operator who is not illustrated throws the recording medium 28 into the throw-in slot 253 in the library apparatus 200, the control unit 21 knows that the recording medium 28 has been thrown into the throw-in slot 253 by the opening/closing detection unit 27 detecting opening and shutting of the throw-in port.

Then, AP_SW which operates in the external apparatus 7 issues a “READ_ELEMENT_STATUS” command that is a command to confirm information which the recording medium 28 in the throw-in slot 253 possesses (information such as a barcode stuck on the recording medium 28: the same can be applied hereinafter) to the library apparatus 200. As a result, the external apparatus 7 begins Import processing of the recording medium 28 thrown into the library apparatus 200.

Next, the control unit 21 conveys the recording medium 28 for which the information possessed by the recording medium 28 is confirmed by the “READ_ELEMENT_STATUS” command by using robot 24 into the medium storage slot 252.

In the third exemplary embodiment mentioned above, an example in which the throw-in slot 253 is correlated to a logical throw-in slot provided in the logical library which has been made to be in “Allow state” by a “PREVENT_ALLOW_MEDIUM_REMOVAL” command issued from the external apparatus 7 in order to begin Import processing has been described.

On the other hand, in this exemplary embodiment, after throwing the recording medium 28 into the throw-in slot 253 by an operator, the external apparatus issues a “READ_ELEMENT_STATUS” command, which is a command about different Import processing, to the library apparatus 200 not having the lock control unit 26 by AP_SW in the external apparatus 7.

Then, the control unit 21 in the library apparatus 200 correlates the throw-in slot 253 to the logical throw-in slot provided in the target logical library by which the “READ_ELEMENT_STATUS” command issued from the external apparatus 7 connects.

Meanwhile, when “READ_ELEMENT_STATUS” commands are received also from other external apparatus 7, the control unit 21 should correlate a logical throw-in slot provided in a target logical library to which the external apparatus 7 having issued the command connects and the shared throw-in slot 253 in order of arrival, for example.

Regarding timing when the external apparatus 7 issues the “READ_ELEMENT_STATUS” command, the external apparatus 7 issues it based on the control unit 21 receiving an opening and shutting notice representing that a throw-in port has been opened and shut from the opening/closing detection unit 27 when an operator throws the recording medium 28 into the shared throw-in slot 253 from outside, and, at the same time, the control unit 21 notifying the external apparatus 7 to the effect that it has confirmed that the recording medium 28 is stored in the throw-in slot 253, for example.

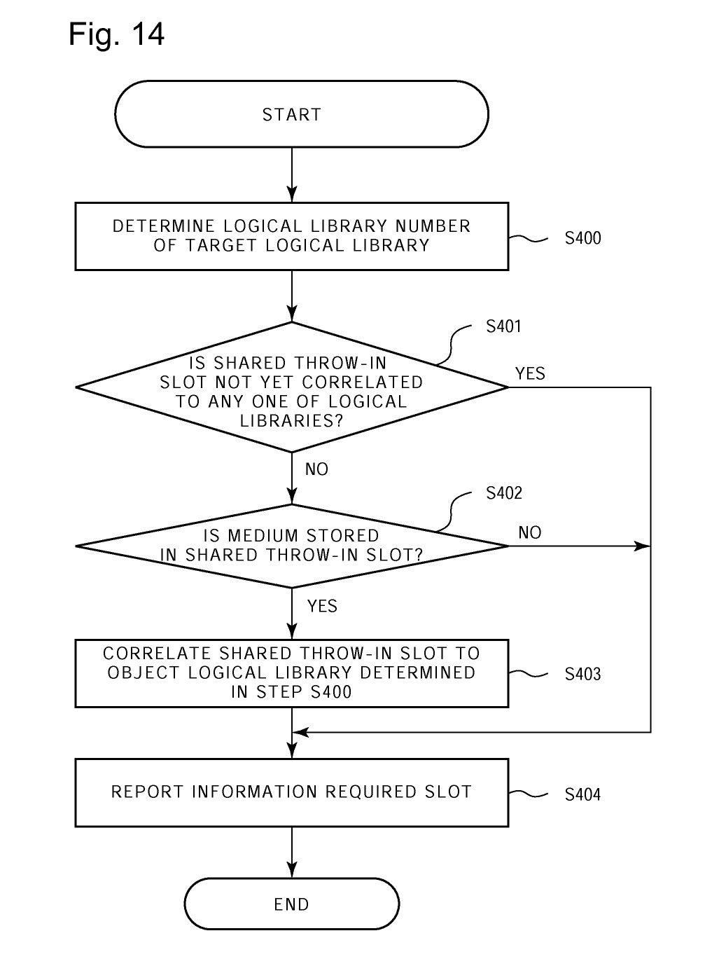

Next, the content of processing by a “READ_ELEMENT_STATUS” command in this exemplary embodiment will be described in detail using the flow chart shown in FIG. 14. FIG. 14 is a flow chart illustrating “READ_ELEMENT_STATUS” command processing in the library apparatus 200 according to this exemplary embodiment.

When an issued “READ_ELEMENT_STATUS” command is received from the external apparatus 7, the control unit 21 in the library apparatus 200 refers to the logical library connection information table 231, compares the port number in the interface 22 that has received the command, the target ID (identifier) and the logical unit number (LUN) with the contents of the table, and determine the logical library number of a target logical library to be connected (Step S400)

Then, the control unit 21 refers to the logical library configuration information table 232, and determines whether the shared throw-in slot 253 has not been already correlated to one of logical libraries or not by whether a physical slot is correlated to the logical throw-in slot in the logical slot number of a logical library (Step S401).

When the throw-in slot 253 has not been correlated to neither of the logical libraries yet (NO, at Step S401), the control unit 21 confirms whether the recording medium 28 is stored in the throw-in slot 253 next (Step S402).

When the recording medium 28 is stored in the throw-in slot 253 (YES, at Step S402), the control unit 21 refers to the logical library configuration information table 232, correlates the throw-in slot 253 to the logical throw-in slot which is a logical throw-in port provided in the logical library expressed by the logical library number determined in Step S400, and updates the logical library configuration information table 232 (Step S403).

The control unit 21 reports information (information such as a barcode stuck on the recording medium 28, for example) representing the recording medium 28 that has been correlated to the target logical library to which performing Import processing has been requested by the “READ_ELEMENT_STATUS” command to the external apparatus 7 (Step S404), and ends the “READ_ELEMENT_STATUS” command processing.

At the time when the “READ_ELEMENT_STATUS” command is accepted from the external apparatus 7, if the throw-in slot 253 to be shared has been already correlated to one of logical libraries (YES, at Step S401), or if the throw-in slot 253 to be shared has not been correlated to any of logical libraries yet and the recording medium 28 is not stored in the throw-in slot 253, the control unit 21 in the library apparatus 200 performs the following processing (NO, at Step S402).

In other words, without changing the association of the throw-in slot 253 to the logical library having the number determined in Step S400, the control unit 21 reports information such as a barcode representing the recording medium 28 that has been correlated to the logical library of a connection object to which performing Import processing has been requested by the external apparatus 7 to the external apparatus 7 (Step S404), and ends the “READ_ELEMENT_STATUS” command processing.

As is the case with the case of NO in Step S302 and the processing indicated in Step S303 in medium transportation processing shown in FIG. 9, the control unit 21 cancels, by “READ_ELEMENT_STATUS” command processing procedure mentioned above, association between the shared throw-in slot 253 and the logical slot number of a logical throw-in slot provided in a target logical library to be connected, when a medium disappears from the throw-in slot 253 having been correlated to the connection object logical library by a medium transportation command from the external apparatus 7 (NO, at Step S402), or when the opening/closing detection unit 27 detects the throw-in slot 253 being opened and shut by an operator.

As mentioned above, even in operation in which taking the recording medium 28 into and out from the library apparatus 200 from outside is not inhibited (in other words, there is no lock control unit, and access to a throw-in port is always possible), the library apparatus 200 according to this exemplary embodiment can correlate a logical throw-in slot provided in a target logical library which has received a “READ_ELEMENT_STATUS” command and the shared throw-in slot 253 taking reception of the command from the external apparatus 7 as an opportunity.

In other words, according to the fourth exemplary embodiment, even in operation in which taking in and out of the recording medium 28 is not inhibited, a shared throw-in slot into which a recording medium has been thrown can be correlated to an appropriate logical library easily using a command different from the command described in the third exemplary embodiment taking the Import processing as an opportunity.

Although description has been made taking the aforementioned configuration and the operation as an example of the fourth exemplary embodiment of the present invention above, the present invention described taking this exemplary embodiment as an example is not limited to the configuration and the operation.

### Fifth Exemplary Embodiment

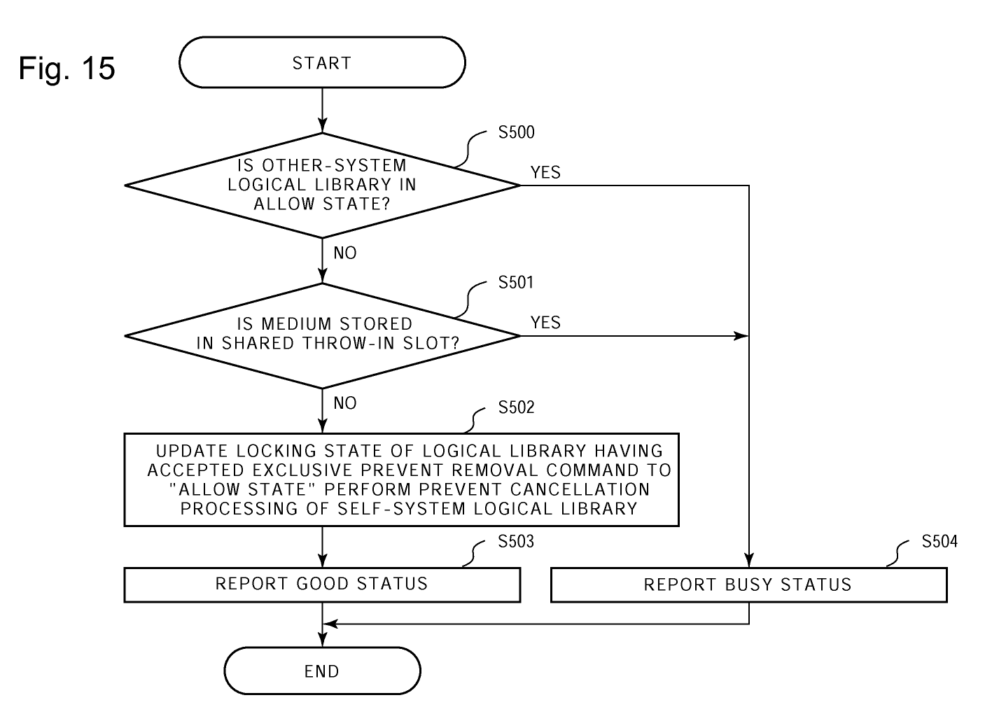

Next, the fifth exemplary embodiment based on the first to fourth exemplary embodiments will be described with reference to FIG. 3, FIG. 6 and FIG. 15. FIG. 15 is a flow chart illustrating exclusive Prevent cancellation processing in which Import processing from a plurality of external apparatus 15 and 16 is carried out exclusively in the library apparatus 100 according to this exemplary embodiment.

The library apparatus 100 according to this exemplary embodiment differs from the first to fourth exemplary embodiments in a point that, in the functions provided in the library apparatus 100 shown in FIG. 3 in the third exemplary embodiment, when pieces of Import processing from a plurality of external apparatus competes, and when a logical library (or, logic throw-in slot which is a logical throw-in port provided in a logical library) of a connection object is in use, a reply (that is, a status report) is made by Busy (that is, a state that it is in use).

Accordingly, in the following description, description will be made centering on a characteristic part of this exemplary embodiment, and overlapped description will be omitted about the same structures as the first to fourth exemplary embodiments mentioned above by attaching the identical reference numbers.

Because the library apparatus 100 according to this exemplary embodiment shown in FIG. 3 is the same as the third exemplary embodiment about a connection relationship with a plurality of external apparatus 15 and 16 and an internal configuration in the library apparatus 100, description here will be omitted.

Meanwhile, regarding the external apparatus 15 and 16 shown in FIG. 3, two external apparatus are indicated as an example for convenience of explanation. However, it is not limited to this number. When a plurality of external apparatus 15 and 16 are collectively called, it may be called the external apparatus 7 for descriptive purpose.

Operations of exclusive Prevent cancellation processing in this exemplary embodiment will be described using a flow chart shown in FIG. 15.

At the time when an operator throws the recording medium 28 into the throw-in slot 253, the control unit 21 in the library apparatus 100 according to this exemplary embodiment receives a “PREVENT_ALLOW_MEDIUM_REMOVAL” command (hereinafter, this command is called an exclusive Prevent removal command for convenience of explanation: the same can be applied hereinafter in this exemplary embodiment) for making the shift to “Allow state” (that is, a state where the recording medium 28 can be thrown in) temporarily, in order to exclusively perform Import processing issued by one of external apparatus.

When an exclusive Prevent removal command is received, the control unit 21 refers to the logical library locking state table 233 indicated in FIG. 6, and confirms whether a permission or inhibition state to throwing (accessing) the recording medium 28 into the shared throw-in slot 253 is not “Allow state” (that is, the permission state) in logical libraries besides one of logical libraries that has accepted the exclusive Prevent removal command (that is, the other-system logical libraries: the same can be applied hereinafter) (Step S500).

When one of logical libraries besides the logical library which has accepted the exclusive Prevent removal command is in “Allow state” (YES, at Step S500), without performing cancellation of “Prevent state” mentioned later, the control unit 21 reports Busy status to the external apparatus 7 that has issued the exclusive Prevent removal command (Step S504).

When all the logical libraries besides the logical library which has accepted an exclusive Prevent removal command are in “Prevent states” (NO, at Step S500), the control unit 21 confirms whether the recording medium 28 is stored in the shared throw-in slot 253 or not (Step S501).

When the recording medium 28 is stored in the throw-in slot 253 (YES, at Step S501), the control unit 21 judges that it is in Import processing based on directions from another external apparatus 7, and reports Busy status to the external apparatus 7 that has issued the exclusive Prevent removal command (Step S504).

When the recording medium 28 is not stored in the throw-in slot 253 (NO, at Step S501), the control unit 21 performs Prevent cancellation processing to the connection object logical library which has accepted the exclusive Prevent removal command (that is, the self-system logical library: the same can be applied hereinafter) because it is a state that Import processing from every external apparatus 7 connected to the library apparatus 100 is not being performed (Step S502).

In Prevent cancellation processing of the logical library concerned, the control unit 21 refers to the logical library locking state table 233 indicated in FIG. 6, updates the locking state of the logical library which has accepted the exclusive Prevent removal command to “Allow state”, and makes the throw-in port of the shared throw-in slot 253 in the library apparatus 100 be in the state that it can be opened and shut from outside.

After that, the control unit 21 reports Good status (that is, a state that it is usable) to the external apparatus 7 that has issued the exclusive Prevent removal command (Step S503), and ends the exclusive Prevent cancellation processing.

In other words, when a locking state is “Allow state” in a logical library besides the target logical library to be connected which has received the exclusive Prevent removal command, that is, an other-system logical library, and when the recording medium 28 is stored in the throw-in slot 253, the control unit 21 in the library apparatus 100 according to this exemplary embodiment judges that it is in the Import processing from another external apparatus.

The control unit 21 performs exclusion (that is, Busy status reporting) processing so that competing Import processing is not begun based on the judgment.

As a result, even when Import processing is performed simultaneously from a plurality of external apparatus, exclusive processing is performed appropriately, and the library apparatus 100 according to this exemplary embodiment can perform Import processing in turn.

Further, in the library apparatus 100 according to this exemplary embodiment, even a logical library of a certain system among logical libraries corresponding to any one of external apparatus is in use, for example, as soon as the other-system logical library becomes available, connection with an external apparatus concerned switches over to the available system automatically, and it can be used immediately (in other words, the availability is high). In such library apparatus 100, because exclusive processing is performed, an erroneous operation (mis-connection) does not occur.

The reason of this is that the control unit 21 in the library apparatus 100 performs control such that an available logical slot may be made be a connection object by replying with Busy status when a logical library to be a target of connection with one of external apparatus is in use.

Although the library apparatus 100 according to this exemplary embodiment has been described using an example having the lock control unit 26 in the third exemplary embodiment, the exclusive control is also possible in the library apparatus 200 not having the lock control unit 26 as it has been described in the fourth exemplary embodiment.

In other words, according to the fifth exemplary embodiment, even if Import processing is performed simultaneously from a plurality of external apparatus, in a target logical library to be connected, a shared throw-in slot into which a recording medium has been thrown can be correlated to an appropriate logical library easily taking the Import processing as an opportunity.

Although the fifth exemplary embodiment of the present invention has been described taking the aforementioned configuration and the operation as an example above, the present invention described taking this exemplary embodiment as an example is not limited to the configuration and the operation.

### Sixth Exemplary Embodiment

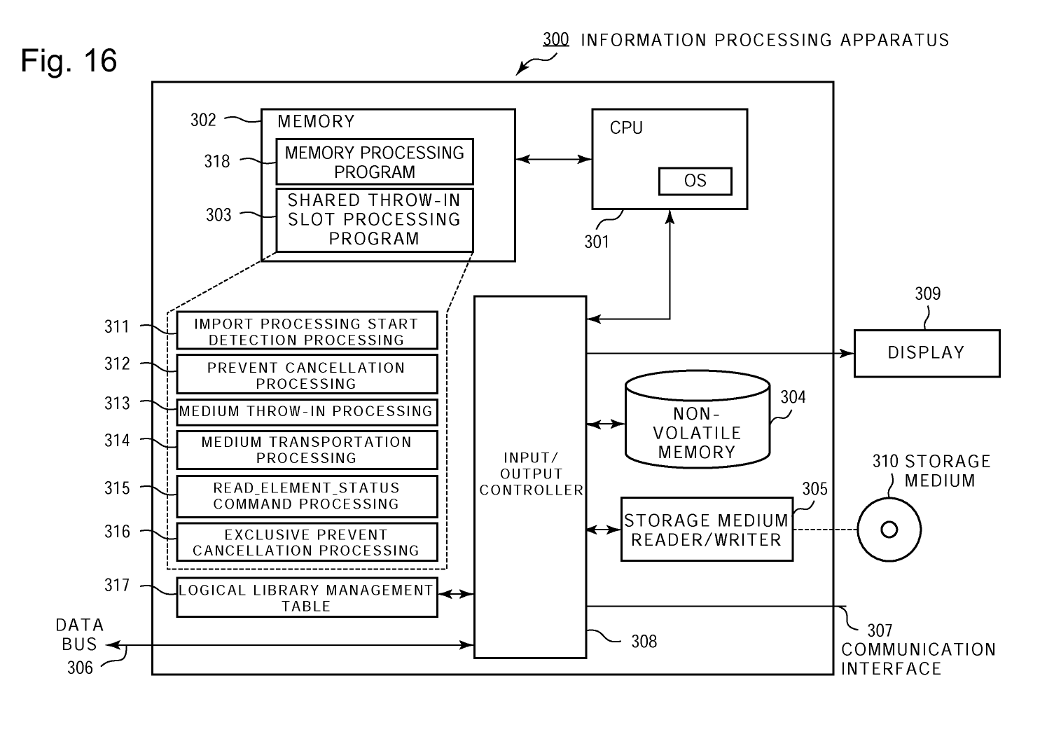

Next, the sixth exemplary embodiment based on the third to fifth exemplary embodiments will be described with reference to FIG. 16. FIG. 16 is a block diagram illustrating a configuration when realizing the functions in the library apparatus 100 according to the third and fifth exemplary embodiments (FIG. 3), the functions in the library apparatus 150 according to the application of the third exemplary embodiment (FIG. 10) and the functions in the library apparatus 200 according to the fourth exemplary embodiment (FIG. 13) by an information processing apparatus 300.

A library apparatus according to this exemplary embodiment differs from the other exemplary embodiments in a point that the functions and the processing in the third to fifth exemplary embodiments is realized by software (SW) including a Central_Processing_Unit (hereinafter, it is abbreviated as “CPU”), an operating system (Operating_System: it is abbreviated as “OS” hereinafter) and an application (AP) in the information processing apparatus 300.

Referring to FIG. 16, the information processing apparatus 300 according to this exemplary embodiment includes a CPU 301, a memory 302, a shared throw-in slot processing program 303, a non-volatile memory 304, a storage medium reader/writer 305 which is used when an application software (AP_SW) is supplied to the information processing apparatus 300, a data bus 306, a communication interface 307, an input/output controller 308, a display 309 and a storage medium 310.

In this exemplary embodiment, the information processing apparatus 300 realizes each function in the block diagram shown in FIG. 3, the tables shown in FIGS. 4 to 6, FIG. 11 and FIG. 12 and each piece of processing in flow charts shown in FIGS. 7 to 9, FIG. 14 and FIG. 15 by the CPU 301 provided in the information processing apparatus 300 shown in FIG. 16, the OS which is software which operates in the CPU 301 and the shared throw-in slot processing program 303 that is a computer program which has been deployed in the memory 302 cooperating with each other.

Meanwhile, in this exemplary embodiment, a computer program which realizes the library apparatus 100 according to the third exemplary embodiment by the information processing apparatus 300 will be described as an example.

However, without being limited to this, also in the application of the third exemplary embodiment and the fourth and fifth exemplary embodiments, it is possible to realize the library apparatus 100, the library apparatus 150 and the library apparatus 200, respectively, by the information processing apparatus 300 using a computer program, by suitably modifying the shared throw-in slot processing program 303 mentioned above and a memory processing program 318 mentioned later.

The memory processing program 318 in the memory 302 is a program for making this information processing apparatus 300 operate as a library apparatus, and, for example, it corresponds to the processing performed by the control unit 21 in each of the exemplary embodiments.

Next, the shared throw-in slot processing program 303 in a library apparatus by this information processing apparatus 300 will be described.

As a processing function, the shared throw-in slot processing program 303 in this information processing apparatus 300 includes each processing program of: an import processing start detection processing 311 which is Import processing for taking a recording medium housing a magnetic recording tape in a cartridge, for example (not shown), into a library apparatus; Prevent cancellation processing 312; medium throw in processing 313; medium transportation processing 314; READ_ELEMENT_STATUS command processing 315; and exclusive Prevent cancellation processing 316.

Meanwhile, through the data bus 306 that is interface mentioned later, for example, a library apparatus by the information processing apparatus 300 can control physical library equipment (not illustrated) outside or inside the information processing apparatus 300 having the slot 25, the robot 24, the lock control unit 26 and the opening/closing detection unit 27 described in the third exemplary embodiment.

On this occasion, by making the memory processing program 318 operate, the information processing apparatus 300 carried out control so that a server, for example, which is the external apparatus 7 and the physical library equipment mentioned above may cooperate with each other.

Then, the import processing start detection processing 311, the Prevent cancellation processing 312, the medium throw in processing 313 and the medium transportation processing 314 in the shared throw-in slot processing program 303 carry out processing corresponding to the flow charts in FIGS. 7 to 9, respectively, with reference to the tables shown in FIGS. 4 to 6 described in the third exemplary embodiment.

The READ_ELEMENT_STATUS command processing 315 carries out processing corresponding to the flow chart in FIG. 14 described in the fourth exemplary embodiment.

The exclusive Prevent cancellation processing 316 carries out processing corresponding to the flow chart in FIG. 15 described in the fifth exemplary embodiment.

Meanwhile, because description of operations using each table and each flow chart which realize each piece of processing mentioned above has been described in the third to fifth exemplary embodiment, description in this exemplary embodiment will be omitted.

This information processing apparatus 300 includes: the storage medium reader/writer 305 that reads and writes the shared throw-in slot processing program 303 in the form of a file and data from outside; the input/output controller 308 that controls input and output of various input/output data possessed in the information processing apparatus 300 by control by OS cooperating with the CPU 301; the data bus 306 capable of performing data exchange with an external apparatus (not illustrated: the same can be applied hereinafter); and the communication interface 307 capable of data communication with an external apparatus (not illustrated: the same can be applied hereinafter).

Meanwhile, the data bus 306 can use a physical interface, a protocol and the like specified by a fibre channel (Fibre_Channel: hereinafter, referred to as “FC”), Serial_Attached_SCSI (Small_Computer_System_Interface) (it is abbreviated as “SAS” hereinafter) and Automation/Drive_Interface (hereinafter, it is abbreviated as “ADI”.) or the like, for example, as an interface. However, a type of data bus 306 is not limited to these.

The original programs of the shared throw-in slot processing program 303 and the memory processing program 318 can be stored in the non-volatile memory 304. When the information processing apparatus 300 starts, the programs can be loaded in the memory 302.

The shared throw-in slot processing program 303 and the memory processing program 318 may be stored in Read_Only_Memory (hereinafter, it is abbreviated as “ROM”) which is not being illustrated as firmware (FW) for controlling the information processing apparatus 300 as a library apparatus.

A library apparatus by the information processing apparatus 300 according to this exemplary embodiment has a logical library management table 317. Meanwhile, the logical library management table 317 has the logical library connection information table 231, the logical library configuration information table 232 and the logical library locking state table 233 described in the third exemplary embodiment.

The logical library management table 317 also has the virtual external apparatus identification table 121 shown in FIG. 11 and the logical library virtual external apparatus table 234 shown in FIG. 12 described in the application of the third exemplary embodiment.

The information processing apparatus 300 may store (update) this logical library management table 317 in a memory unit or the like (not illustrated) which can be read and written other than the memory 302, or may store (update) it in the memory 302 along with the shared throw-in slot processing program 303.

An operator who operates a library apparatus by the information processing apparatus 300 can make a situation of a shared throw-in slot (not shown) having been correlated to a logical library be indicated on the display 309, for example, and manage operation of the library apparatus based on the indication.

Also, the display 309 can indicate an operating situation of a server which is the external apparatus 7, a logical slot (logic throw-in slot) in a logical library, a physical slot in the physical library and a shared throw-in slot (in other words, such as presence or absence of a recording medium) along with their slot numbers, for example.

As a result, when the recording medium 28 is thrown into this library apparatus from outside, an operator can recognize easily that a shared throw-in slot is appropriately correlated to a logical throw-in slot provided in the logical library.

The information processing apparatus 300 according to this exemplary embodiment provides each block diagram in the library apparatus 100 (FIG. 3), 150 (FIG. 10) and 200 (FIG. 13) mentioned above, and each flow chart illustrating their control (FIGS. 7 to 9, FIG. 14 and FIG. 15) as a realizable computer program, that is, the shared throw-in slot processing program 303.

The operations of a library apparatus described in the third to fifth exemplary embodiments are achieved by reading the shared throw-in slot processing program 303 in the memory 302 and carrying out it using the above-mentioned CPU 301 and the cooperating OS that are prepared as a control method of a library apparatus by the information processing apparatus 300.

As a method of supplying a computer program mentioned above to the information processing apparatus 300, a method to install it in the information processing apparatus 300 using the storage medium reader/writer 305 via various types of computer-readable storage medium 310 such as a disk media such as a floppy (registered trademark) disk and CD-ROM (Compact_Disc-Read_Only_Memory) and memory media such as a Universal_Serial_Bus (it is abbreviated as “USB” hereinafter) memory can be adopted.

Also, as a supply method of a computer program mentioned above to the information processing apparatus 300, a procedure that is general nowadays such as a method to install it from an external apparatus via the data bus 306, or a method to download it from an external apparatus via a wired or wireless communication line that enables communication such as the internet using the communication interface 307 can be adopted.

In such cases, this exemplary embodiment can be thought that it is formed by cords constituting a computer program or the non-transitory computer-readable storage medium 310 in which such cords are recorded.

A library apparatus using the general-purpose information processing apparatus 300 may be realized by dedicated equipment.

This exemplary embodiment takes the third to fifth exemplary embodiments as a basis. Therefore, this exemplary embodiment has the effect provided by the third to fifth exemplary embodiments similarly.

In other words, according to the sixth exemplary embodiment, a shared throw-in slot into which a recording medium has been thrown can be correlated to an appropriate logical library easily.

Although the sixth exemplary embodiment of the present invention has been described taking the aforementioned configuration and the operation as an example above, the present invention described taking this exemplary embodiment as an example is not limited to the configuration and the operation.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A library apparatus, comprising:
a slot shared when throwing a recording medium into the slot;
a logical library information including connection information of a logical library and an external apparatus connected to the logical library, the logical library packs a physical library storing the recording medium having been thrown in the slot based on a number, which is larger than a number of pieces of the slot accessible independently, and represents the packed each area of the physical library; and
a control unit to control so as the slot is correlated to the logical library; wherein
the control unit:
in case that import processing to take the recording medium into the external apparatus is directed, identifying, by referring to the logical library information, the logical library connected to the external apparatus which directed the import processing; and
correlating the slot having been thrown the recording medium to the identified logical library.

2. The library apparatus according to claim 1, wherein
the logical library information includes logical library connection information including information representing connection between the logical library and the external apparatus, and
in response to receiving a command from the external apparatus having directed the import processing, the control unit determines, by referring the logical library connection information, a specific one of the logical library to be a destination of correlated connection by the external apparatus.

3. The library apparatus according to claim 1, wherein
the logical library information further includes logical library locking status information which holds information for permitting or inhibiting to throw the recording medium into the slot,
the control unit refers to the logical library locking status information in case that the import processing is started in accordance with the external apparatus receives a command directing the import processing; and
in case that access is in an inhibiting state, the access being an operation for throwing the recording medium having been thrown into the slot or taking the recording medium out from the logical library concerned, the control unit correlates the slot having been thrown the recording medium to the logical library as a target of the received import processing by setting the access inhibiting state to an access permission state.

4. The library apparatus according to claim 1, wherein
in response to receiving a first command issued by the external apparatus for allowing to throw the recording medium into the slot, the control unit refers to a logical library connection information table which is the logical library connection information and identifies a logical library number in a target logical library as a target of connection by the external apparatus based on a result of comparing in case that receiving the first command, a port number representing a port in an interface provided in the library apparatus, a target identifier for identifying the logical library to be connected to the port logically and a logical unit number possessed by the logical library concerned, and
the control unit further refers to a logical library locking state table which is the logical library locking status information, and, in case that a state representing permitting or inhibiting to throw the recording medium into the logical slot provided in the target logical library represented by the logical library number, is in an inhibiting state, sets the state to a permission state, and cancels locking of a throw-in port of the slot by controlling of a lock control unit.

5. The library apparatus according to claim 4, further comprising:
a lock control unit to inhibit and permit opening and shutting of the throw-in port used when taking the recording medium in and out of the slot to be shared; and
an opening/closing detection unit to detect opening and shutting of the throw-in port, wherein,
the control unit confirms whether the recording medium is stored or not by detecting throwing-in of the recording medium to the slot, the locking of the slot having been cancelled by the lock control unit, by the opening/closing detection unit in the throw-in port, and, in case that the recording medium is stored in the slot as a result, referring to the logical library locking state table, acquires the logical library number representing the permission state, regarding a state of permitting or inhibiting to throw the recording medium into the slot provided in the target logical library represented by the logical library number of a connection target of the external apparatus, and correlates the slot to be shared to the logical slot in the logical library having the acquired logical library number.

6. The library apparatus according to claim 4, further comprising:
in the logical library information, a logical library configuration information table which is a logical library configuration information representing relation between a physical slot forming the physical library and a logical slot in the logical library correlated to the physical slot; and
in the library apparatus, a transport device to transport the recording medium in a slot, the slot being the physical library to store the recording medium, wherein,
in case that the slot having the recording medium having been thrown in is correlated to the logical slot logically, the control unit confirms that the recording medium is stored in the slot, and
in response to receiving a second command for transporting the recording medium issued by the external apparatus, the control unit moves, by using the transport device to transport the recording medium to a transportation destination from a transportation origin expressed in the physical slot number corresponding to the logical slot number indicated by the logical library configuration information table designated by the second command, the recording media from the transportation origin to the transportation destination, and, in case that none of the recording medium is stored in the slot, cancels association of the logical slot and the slot with reference to the logical library configuration information table.

7. The library apparatus according to claim 4, wherein
the control unit:
in case that the library apparatus doesn't have the lock control unit and the external apparatus performing import processing of the recording medium thrown into the slot to be shared, refers to the logical library connection information table in response to receiving a third command issued by the external apparatus for confirming whether the recording medium is stored in the slot, and, based on a result of comparing a port number representing a port in interface provided in the library apparatus, the port having been used at the time of receiving the third command, a target identifier for identifying the logical library to be connected to the port logically and a logical unit number possessed by the logical library concerned, identifies the logical library number in a target logical library of a target of connection by the external apparatus, and, referring to the logical library configuration information table, in case that the slot isn't correlated to neither of the logical libraries and the recording medium being stored in the slot, refers to the logical library configuration information table and correlates the slot to the target logical library having the identified logical library number, and reports information about the recording medium in the logical slot provided in the target logical library required by the third command.

8. The library apparatus according to claim 3, wherein
the control unit:
in case that import processing is performed from a plurality of pieces of the external apparatus connected, refers to the logical library locking state table at the time of receiving the first command, and, in case that a state for one of permitting and inhibiting to correlate the recording medium to the logical slot possessed by an other-system logical library, the other-system logical library being one of logical libraries besides the logical library having accepted the first command, being a permission state, does not perform processing for cancelling an inhibiting state of the association, and, in case that the other-system logical library having accepted the first command is in an inhibiting state about throwing the recording medium in, and the recording medium being stored in the slot to be shared, reports to the external apparatus having issued the first command to the effect of being in use; and
in case that the other-system logical library having accepted the first command is in an inhibiting state about correlating the recording medium and the recording medium being not stored in the slot to be shared, cancels the inhibiting state of correlation in the logical library having accepted the first command, refers to the logical library locking state table, updates a locking state of the logical library having accepted the first command to a permission state so as to allow a throw-in port in the slot to be shared to be opened and shut, and reports to the external apparatus having issued the first command to the effect of being usable.

9. A control method of a library apparatus, by utilizing the library apparatus including:
a slot shared when throwing a recording medium into the slot;
a logical library information including connection information of a logical library and an external apparatus connected to the logical library, the logical library packs a physical library storing the recording medium having been thrown in the slot based on a number, which is larger than a number of pieces of the slot accessible independently, and represents the packed each area of the physical library; and
a control unit to control so as the slot is correlated to the logical library;
by the control unit:
in case that import processing to take the recording medium into the external apparatus is directed, identifying, by referring to the logical library information, the logical library connected to the external apparatus which directed the import processing; and
correlating the slot having been thrown the recording medium to the identified logical library.

10. A non-transitory storage medium storing a computer program of a library apparatus, the library apparatus including:
a slot shared when throwing a recording medium into the slot;
a logical library information including connection information of a logical library and an external apparatus connected to the logical library, the logical library packs a physical library storing the recording medium having been thrown in the slot based on a number, which is larger than a number of pieces of the slot accessible independently and represents the packed each area of the physical library; and
a control unit to control so as the slot is correlated to the logical library, the computer program causing a computer to realize:
identifying function, by referring to the logical library information in case that import processing to take the recording medium into the external apparatus is directed, that identifies the logical library connected to the external apparatus which directed the import processing; and
correlating function that correlates the slot having been thrown the recording medium to the identified logical library.
